(19) United States
(12) Patent Application Publication
(10) Pub. No.: US 2011/0196902 A1
(43) Pub. Date: Aug. 11, 2011

(54) ELECTRONIC DEVICE AND IMAGE PROCESSING METHOD THEREOF

(75) Inventor: CHI-CHENG KANG, Tu-Cheng (TW)

(73) Assignee: CHI MEI COMMUNICATION SYSTEMS, INC., Tu-Cheng City (TW)

(21) Appl. No.: 12/979,358

(22) Filed: Dec. 28, 2010

(30) Foreign Application Priority Data
Feb. 6, 2010 (TW) 99103701

(51) Int. Cl. G06F 17/30

(52) U.S. Cl. 707/822; 707/E17.008

(57) ABSTRACT

An image processing method using an electronic device configures additional information into an image file. The electronic device acquires the image file stored in a storage unit and adds the additional information into at least one image layer of the image file. A user can determine whether both the additional information of the image file and the image file are displayed in a display unit at the same time.

### BACKGROUND

1. Technical Field

The present disclosure relates to an electronic device, and more particularly to an electronic device for configuring additional information into an image file.

2. Description of Related Art

Portable devices, such as smart phones, are often used for taking images. Users may want to add additional information into the taking images, such as text, icon or audio information, into image data of the images so as to provide more information in a single image. But conventional portable devices do not have the proper function to add information into the image file while maintaining superior compatibility at the same time. Thus, convenience for the user is affected.

### BRIEF DESCRIPTION OF THE DRAWINGS

FIG. 1 is a block diagram of one embodiment of an electronic device.

FIG. 2 is a block diagram of one embodiment of an amended JPEG file structure with an additional data section.

FIG. 3 is a flowchart of one embodiment of an image processing method using an electronic device.

### DETAILED DESCRIPTION

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage unit device.

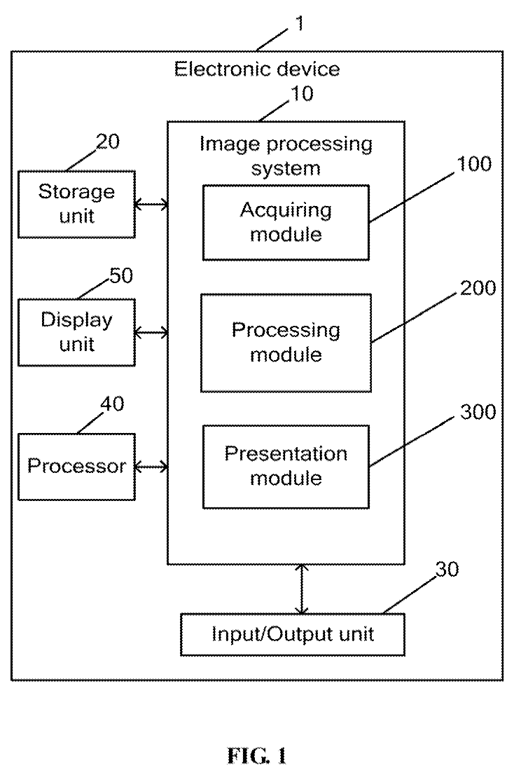

FIG. 1 is the block diagram of one embodiment of an electronic device 1. The electronic device 1 includes an image processing system 10, a storage unit 20, an input/output unit 30, a processor 40 and a display unit 50. The image processing system 10 includes an acquiring module 100, a processing module 200 and a presentation module 300. Depending on the embodiment, the electronic device 1 may be a mobile phone, a personal digital assistant (PDA), a handheld game console, a digital camera (DC), or a handheld computer, or other device.

The electronic device 1 is generally controlled and coordinated by an operating system, such as UNIX, Linux, Windows, Mac OS, an embedded operating, or any other compatible system. Alternatively, the electronic device 1 may be controlled by a proprietary operating system. Typical operating systems control and schedule computer processes for execution, perform memory management, provide file system, networking, and I/O services, and provide a user interface, such as a graphical user interface (GUI), among other tasks.

The storage unit 20 is electronically connected to the image processing system 10, the input/output unit 30, the processor 40 and the display unit 50. The storage unit 20 is operable to store many kinds of data, such as an image file, a customization function code of the electronic device 1, computerized codes of the image processing system 10, programs of an operating system and other applications of the electronic device 1. The storage unit 20 may include a hard disk drive, flash memory, RAM, ROM, cache, or external storage mediums.

The processor 40 controls one or more computerized codes of the image processing system 10, the storage unit 20, the input/output unit 30, and the display unit 50 to perform their individual functions. In one embodiment, the acquiring module 100 accesses the image file stored in the storage unit 20. For example, the image file may be a JPEG file. However, image formats, which support user to create definable application in an extension section of image formats, such as JPEG, TIFF, and RAW are also able to be processed.

The display unit 50 displays the image file and additional information of the image file stored in the storage unit 20. The display unit 14 can be a display screen, a resistive touch screen, or a capacitive touch screen.

The acquiring module 100 is operable to acquire the image file stored in the storage unit 20. In one embodiment, the image file is the JPEG file. The processing module 200 further edits acquired JPEG files as defined in the below disclosure. It should be understood that the JPEG 2000 specification defines that developer can design add data section to store the additional information into standard JPEG 2000 structure.

The processing module 200 is operable to add at least one application into the extension section and at least one image layer into the at least one application. The at least one image layer contains the additional information. In one embodiment, the extension section can be an EXIF tag structure. The type of the additional information can be text or icons.

The presentation module 300 presents the image file with the additional information of the image file. In one embodiment, in conjunction with the input/output unit 30, the presentation module 300 provides an interface to user. The interface allows user to choice whether the additional information of the image file is shown. If a user choices to show the additional information, the presentation module 300 presents both the additional information and the image file at the same time. If the user choices to hide the additional information, the presentation module only presents the image file.

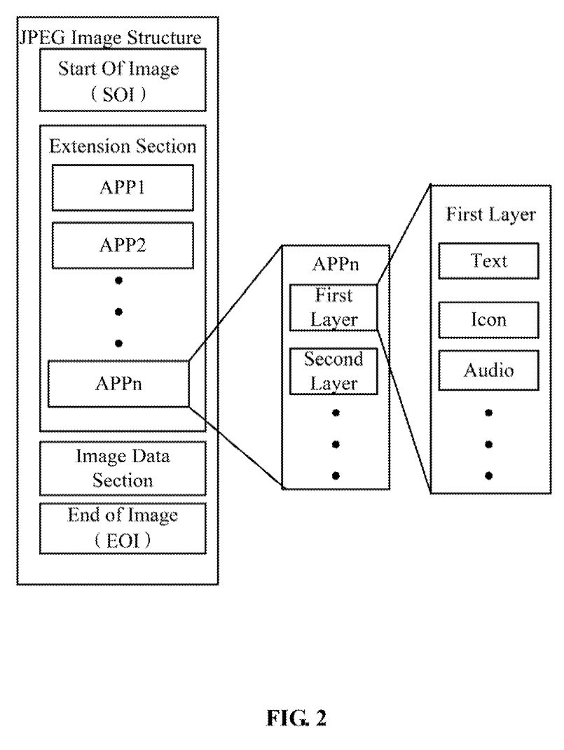

FIG. 2 is a block diagram of an amended image file structure with additional data sections of one embodiment of the present disclosure. For example, the amended image file is a JPEG file structure. The JPEG file structure includes a header (start of image), an extension section, an image data section, and an ender (end of image). A user is allowed to create the at least one application at the extension section through the processing module 200 of the image processing system 10.

In one embodiment, the processing module 200 creates a first image layer and a second image layer in the extension section. In accordance with the JPEG 2000 specification, a bit-stream of an image that is split into packets where a packet groups selected passes of all code blocks from a precinct into one indivisible unit. Packets are the key to quality scalability (i.e., packets containing less significant bits can be discarded to achieve lower bit rates and higher distortion).

Packets from all sub-bands are then collected in so-called layers. The way the packets are built up from the code-block coding passes, and thus which packets a layer will contain, is not defined by the JPEG 2000 standard, but in general a codec will try to build layers in such a way that the image quality will increase monotonically with each layer, and the image distortion will shrink from layer to layer. Thus, layers define the progression by image quality within the code stream. The layers store the additional information in the JPEG file.

In addition, the processing module 200 adds the additional information into the layers. In one embodiment, the electronic device 1 is the mobile phone. The processing module 200 provides an interface to user. For example, the interface is the graphic user interface displayed in the display unit 50. The user is able to add the additional information, such as text content, positions of text, colors of the text, position of the image and shape of the image edge, through the interface. In addition, the interface can be a touch screen and user can input the additional information by touching the touch screen. Some user defined icons can also be defined as the additional information.

The processing module 200 inserts the additional information into corresponding layers in accordance with corresponding image protocol so as to remain the image readable by other electronic devices only capable of reading standard image format in compliance with image protocols. For example, the protocol is an image browsing protocol. In one embodiment, since the additional information is defined in the JPEG 2000 specification and states that a JPEG reader should bypass any undefined application or layer when the JPEG reader reads a JPEG file. Thus, a JPEG file with the additional information can also be read at any JPEG reader so as to increase better compatibility of the processed JPEG image file. Moreover, the processing module 202 adds audio information as the additional information into the at least one image layer. The audio information of the additional information can be displayed by the input/output unit 30. For example, the input/output unit 30 may be a speaker of the electronic device 1.

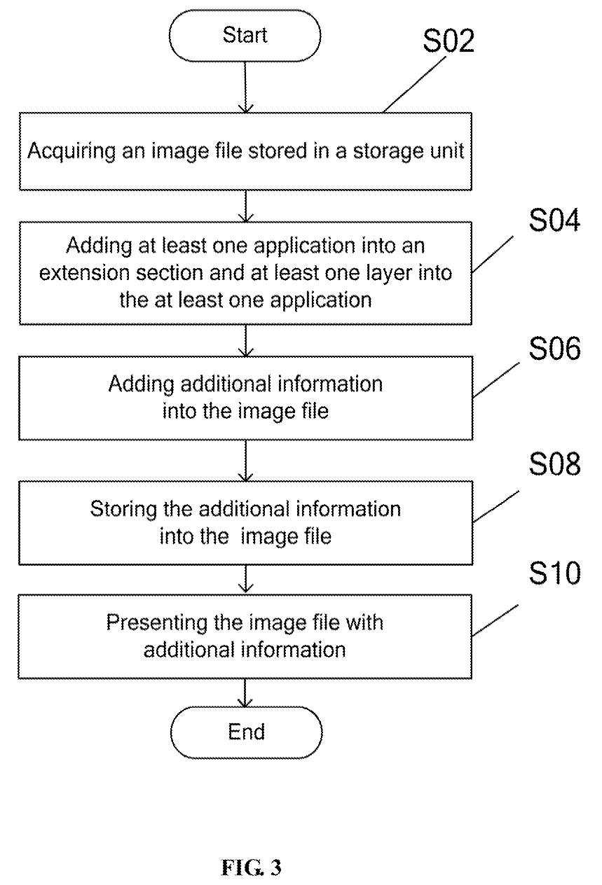

FIG. 3 is a flowchart of one embodiment of an image processing method using an electronic device 1. The image processing method processes an image file stored in the electronic device 1. In one embodiment, the image file is a JPEG file. Depending on the embodiment, additional blocks may be added, others deleted, and the ordering of the blocks may be changed.

In block S02, the acquiring module 100 acquires an image file stored in the storage unit 20

In block S04, the processing module 200 adds at least one application into an extension section of the JPEG file and at least one image layer into the at least one application. Additional information is contained in the at least one image layer. In one embodiment, the extension section can be an EXIF tag structure. The type of the additional information is text or icons.

In block S06, the processing module 200 adds the additional information into the at least one layer of the at least one application of the JPEG file. In one embodiment, audio information can be added as the additional information into the at least one image layer.

In block S08, the processing module 200 stores the additional information into corresponding layers according to the way complying with standard protocol.

In block S10, the presentation module 300 presents the JPEG file in the display unit 50 according to a user's instruction. If the user choice to show all information of the JPEG file, the presentation module 300 presents both the additional information and the JPEG file at the same time in the display unit 50 through the graphic user interface. If the user only wants to show the JPEG file, the presentation module 300 shows the JPEG file solely.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage unit;
a display unit;
a processor;
one or more programs that are stored in the storage unit and are executed by the processor, the one or more programs comprising:
an acquiring module operable to acquire an image file stored in the storage unit;
a processing module operable to add at least one application into an extension section of the image file and at least one image layer into the at least one application; and
a presentation module operable to present the image file with additional information of the image file.

2. The electronic device of claim 1, wherein the additional information of the image file is text or icons.

3. The electronic device of claim 1, wherein the at least one layer reserves the additional information added into the image file by the processing module in accordance with a protocol corresponding to the image file.

4. The electronic device of claim 1, wherein the acquiring module and the processing module are controlled by the processor.

5. The electronic device of claim 1, wherein the processing module further adds audio information as the additional information into the at least one image layer.

6. The electronic device of claim 1, wherein the image file is JPEG, TIFF, or RAW data.

7. The electronic device of claim 3, wherein the protocol is an image browsing protocol.

8. An image processing method using an electronic device, the electronic device comprising a storage unit, comprising:
acquiring an image file stored in the storage unit of the electronic device;
adding at least one application into an extension section of the image file and at least one image layer into the at least one application;
adding additional information of the image file into the at least one image layer; and
storing the additional information of the image file into the at least one image layer.

9. The image processing method of claim 8, further comprising:
presenting the image file with the additional information of the image file.

10. The electronic device of claim 8, wherein the additional information of the image file is text or icons.

11. The image processing method of claim 8, wherein the step of adding additional information of the image file further comprises:
adding audio information as the additional information of the image file into the at least one image layer.

12. The image processing method of claim 8, wherein the image file is JPEG, TIFF, or RAW Data.

13. A storage medium having stored thereon instructions that, when executed by a processor, causes the processor to perform an image processing method using an electronic device, the electronic device comprising a storage unit, the method comprising:
acquiring an image file stored in the storage unit of the electronic device;
adding at least one application into an extension section of the image file and at least one image layer into the at least one application;
adding additional information of the image file into the at least one image layer; and
storing the additional information of the image file into the at least one image layer

14. The storage medium of claim 13, the method further comprising:
presenting the image file with the additional information of the image file.

15. The storage medium of claim 13, wherein the additional information of the image file is text or icons.

16. The storage medium of claim 13, wherein the step of adding additional information of the image file further comprises:
adding audio information as the additional information of the image file into the at least one image layer.

17. The storage medium of claim 13, wherein the image file is JPEG, TIFF, or RAW Data.
